(19) United States
(12) Patent Application Publication
(10) Pub. No.: US 2016/0004747 A1
(43) Pub. Date: Jan. 7, 2016

(54) JOIN QUERY EXECUTION METHOD AND DEVICE, AND STORAGE MEDIUM

(71) Applicant: HITACHI, LTD., Chiyoda-ku, Tokyo (JP)

(72) Inventors: Shohei MATSUURA, Tokyo (JP); Yukio NAKANO, Tokyo (JP); Masashi TSUCHIDA, Tokyo (JP)

(21) Appl. No.: 14/771,112

(22) PCT Filed: May 23, 2013
(86) PCT No.: PCT/JP2013/064323

§ 371 Date: Aug. 27, 2015

(51) Int. Cl. G06F 17/30

(52) U.S. Cl. CPC G06F 17/30466; G06F 17/30454; G06F 17/30498

(57) ABSTRACT

A join query execution method and device include a processor and storage medium. An external data source connected to a data management system by a table function is searched, regarding and joining processing against a join query regarding a search result of the table function and a table managed by the data management system, the joining processing is executed on the search result by a first joining method; a join query execution device determines whether the first joining method is appropriate, by using information acquired by search processing on the external data source; and when it is determined that the first joining method is not appropriate, the join query execution device recognizes a speed of a second joining method to be higher than that of the first joining method and switches the joining method for the joining processing to the second joining method.

### TECHNICAL FIELD

The present invention relates to a join query technique used with respect to a database and is suited for use in a search system capable of conducting a cross search.

### BACKGROUND ART

In recent years, attention has been drawn up to a technique searching both non-structural data such as texts, sounds and images, and structural data in a field making use of data (hereinafter referred to as “cross search”). As one realized aspect of the cross search, there is a method of using a table function, which is a standard for SQL (Structured Query Language) 2003, in a system where a relational database management system (hereinafter referred to as “RDBMS [Relational DataBase Management System]), for managing the structural data, works with a search engine, graph database and social network for managing and searching the non-structural data (hereinafter referred to as the external data source).

The table function herein mentioned which is the standard for the SQL 2003 (hereinafter simply referred to as the “table function”) is a standard for referring to a function described by a user with the SQL and invoking it upon the SQL execution and its execution result is a row set. Since the execution result of the table function is the row set, it is possible to refer to the execution result by using a SELECT statement of the SQL and combine the execution result with another table.

Regarding the cross search using a table function of the SQL, a non-structural data search request is issued to the external data source, a function which describes processing for receiving the search result on the RDBMS side is defined, and the search of the non-structural data is conducted by executing that function when executing the SQL. The cross search realizes utilization of both the structural data and the non-structural data by joining the search results of the structural data and the non-structural data.

Incidentally, PTL 1 discloses a technique that optimizes a query for the cross search by executing cost calculation at the time of compilation of the query with respect to a table of the RDBMS and the query to search the external data source.

Moreover, NPL 1 discloses a technique that executes a query by embedding statistic information inside the RDBMS, which is used when generating a plan of query processing, into the plan, acquiring the statistic information during execution of the query processing, and switching the plan to an optimum plan if there is a gap between the acquired statistic information and the statistic information used when generating the plan.

Furthermore, NPL 2 discloses a technique that executes a query by switching the plan to an optimum plan as in the same manner as in NPL 1 if there is a gap between the statistic information inside the RDBMS, which is used when generating the plan of the query processing, and the statistic information acquired during execution of the query.

### CITATION LIST

### Patent Literature

[PTL 1] U.S. Pat. No. 5,943,666

### Non Patent Literature

[NPL 1] Kabra, N., DeWitt, D.: “Efficient Mid-Query Re-Optimization of Sub-Optimal Query Execution) ans”, SIGMOD, pp. 106-117, 1998, (ISBN: 0-89791-995-5)

[NPL 2] Eurviriyanukul, K et al.: “Adaptive Join Processing in Pipelined Plans.”, ACM, EDBT '10 Proceedings of the 13th International Conference on Extending Database Technology, pp. 183-194, 2010, (ISBN: 978-1-60558-945-9)

### SUMMARY OF INVENTION

### Technical Problem

Meanwhile, regarding the cross search, there is a high demand to combine the search result of the non-structural data and the structural data in a short amount of time.

However, according to the technique disclosed in PTL 1, a cost of executing the query processing is estimated when compiling before execution of the query processing, and the query is executed in a short amount of time by optimizing the query execution. Thus, in case there is a gap between the cost estimated at the time of the compilation and an actual query cost, the problem of incapability to execute the query in an optimum plan and lengthening of the query time occurs. Furthermore, when the cross search is conducted by using the table function, the query result will vary considerably depending on an argument of the table function. Therefore, the query execution cost will vary greatly. However, since it is impossible to predict the result of the query and estimate the cost at the time of the query compilation, the query plan, including determination of an optimum joining method, cannot be optimized.

Furthermore, regarding the cross search, the statistic information of the table function which issues a search request to the external data source does not exist at the time of the compilation. Therefore, it is impossible to apply the techniques like those disclosed in NPL1 and NPL2 based on the existence of the statistic information regarding the query at the time of the compilation.

The present invention was devised in consideration of the above-described circumstances and it is an object of the present invention to achieve a database technique enabling to execute processing of join query at high speed.

### Solution to Problem

In order to solve the above-described problems, the present invention provides a join execution method executed by a join query execution device for searching an external data source connected to a data management system by means of a table function and executing joining processing against a join query regarding a search result of the table function and a table managed by the data management system, wherein the join execution method includes: a first step executed by the join query execution device executing the joining processing regarding the search result of the table function and the table managed by the data management system by a first joining method; a second step executed by the join query execution device determining whether the first joining method is an appropriate joining method as a joining method for the joining processing or not, by using information acquired by search processing on the external data source by means of the table function and/or information found during the joining processing; and a third step executed by the join query execution device, when it is determined that the first joining method is not the appropriate joining method as the joining method for the joining processing, recognizing a speed of a second joining method to be higher than that of the first joining method and switching the joining method for the joining processing from the first joining method to the second joining method.

Furthermore, in the present invention, a join query execution device searches an external data source connected to a data management system by means of a table function, and executes joining processing against a join query regarding a search result of the table function and a table managed by the data management system, wherein the join query execution device comprises: a table function unit that searches the external data source by issuing a search request to the external data source; a joining execution unit that executes the joining processing regarding the search result of the table function and the table managed by the data management system by a first joining method or a second joining method whose processing speed is faster than that of the first joining method; a switch command unit that determines whether the first joining method is an appropriate joining method as a joining method for the joining processing or not, by using information acquired by search processing on the external data source by the table function unit and/or information found during the joining processing, and gives a command to the joining execution unit to switch the joining method for the joining processing to the second joining method when it is determined that the first joining method is not the appropriate joining method as the joining method for the joining processing; and a control unit that controls activation of the table function unit, the joining execution unit, and the switch command unit.

Furthermore, the present invention is created so that a program is stored for comprising a join query execution device search an external data source connected to a data management system by means of a table function and execute joining processing against a join query regarding a search result of the table function and a table managed by the data management system, wherein the processing includes: a first step of executing the joining processing regarding the search result of the table function and the table managed by the data management system by a first joining method; a second step of determining whether the first joining method is an appropriate joining method as a joining method for the joining processing or not, by using information acquired by search processing on the external data source by means of the table function and/or information found during the joining processing; and a third step, which is executed when it is determined that the first joining method is not the appropriate joining method as the joining method for the joining processing, of recognizing a speed of a second joining method to be higher than that of the first joining method and switching the joining method for the joining processing from the first joining method to the second joining method.

### Advantageous Effects of Invention

According to the present invention, since the joining method can be switched to an appropriate joining method during the joining processing, it is possible to increase the speed of join query execution processing.

### BRIEF DESCRIPTION OF DRAWINGS

FIG. 1 is a block diagram illustrating an overall configuration of a search system according to a first embodiment;

FIG. 2(A) is a diagram illustrating an example of a query transmitted from a client to an RDBMS server and FIG. 2(B) is a conceptual diagram illustrating a query processing plan created for the relevant query;

FIG. 3 is a flowchart illustrating a plan of a query processing control unit;

FIG. 4 is a block diagram illustrating the configuration of a joining processing unit according to the first embodiment;

FIG. 5 is a block diagram illustrating the configuration of a table-function-and-base-table joining unit for the joining processing unit according to the first embodiment;

FIG. 6 is a flowchart illustrating a procedure of a control unit for the table-function-and-base-table joining unit;

FIG. 7 is a flowchart illustrating a procedure of a joining execution unit according to the first embodiment;

FIG. 8 is a diagram illustrating an example of threshold information according to the first embodiment;

FIG. 9 is a flowchart illustrating a procedure of a switch command unit according to the first embodiment;

FIG. 10 is a block diagram illustrating the configuration of a table function unit according to the first embodiment;

FIG. 11 is a flowchart illustrating a procedure of the table function unit according to the first embodiment;

FIG. 12 is a diagram illustrating a processing flow of an execution sequence for a join query executed by the table-function-and-base-table joining unit after compilation of the join query according to the first embodiment;

FIG. 13 is a block diagram illustrating the configuration of a table-function-and-base-table joining unit for a joining processing unit according to a second embodiment;

FIG. 14 is a flowchart illustrating a procedure of a joining execution unit according to the second embodiment;

FIG. 15 is a diagram illustrating an example of threshold information according to the second embodiment;

FIG. 16 is a flowchart illustrating a procedure of a switch command unit according to the second embodiment;

FIG. 17 is a diagram illustrating a processing flow of an execution sequence for a join query executed by the table-function-and-base-table joining unit after compilation of the join query according to the second embodiment;

FIG. 18 is a block diagram illustrating the configuration of a table-function-and-base-table joining unit for a joining processing unit according to a third embodiment;

FIG. 19 is a flowchart illustrating a procedure of a joining execution unit according to the third embodiment;

FIG. 20 is a diagram illustrating an example of threshold information according to the third embodiment;

FIG. 21 is a flowchart illustrating a procedure of a switch command unit according to the third embodiment;

FIG. 22 is a block diagram illustrating the configuration of a table function unit according to the third embodiment;

FIG. 23 is a flowchart illustrating a procedure of the table function unit according to the third embodiment; and

FIG. 24 is a diagram illustrating a processing flow of an execution sequence for a join query executed by the table-function-and-base-table joining unit after compilation of the join query according to the third embodiment.

### DESCRIPTION OF EMBODIMENTS

An embodiment of the present invention will be described in detail below with reference to drawings.

### (1) First Embodiment

### (1-1) Configuration of Search System According to this Embodiment

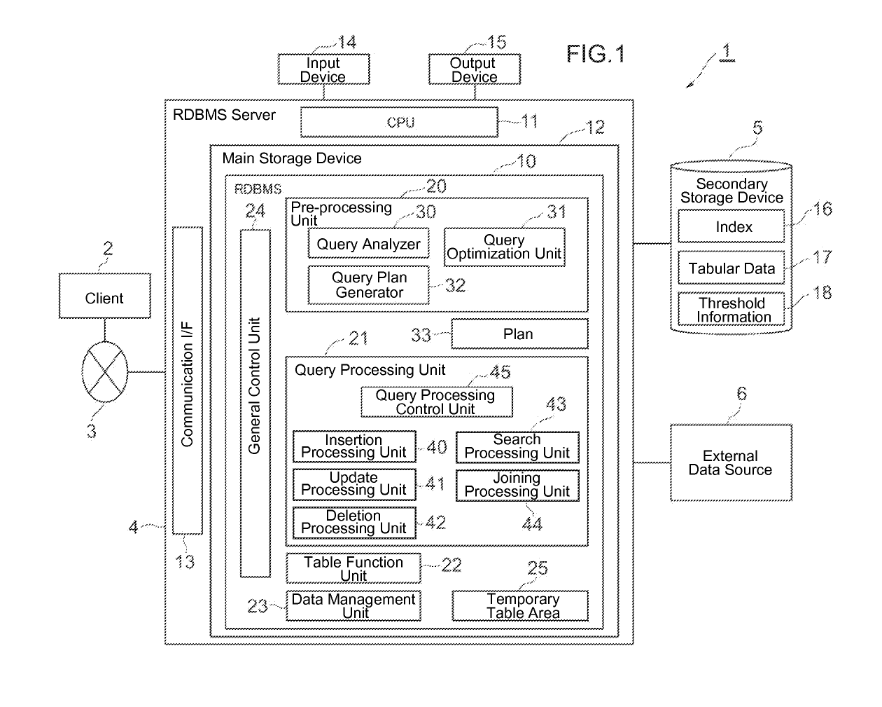

Referring to FIG. 1, reference numeral 1 represents a search system according to this embodiment as a whole. This search system 1 is configured so that a client 2 is connected to an RDBMS server 4 via a network 3 and a secondary storage device 5 and an external data source 6 are connected to the RDBMS server 4.

The client 2 is a computer device used by a user and is configured of, for example, a personal computer, a workstation, or a mainframe. The client 2 sends a query to the RDBMS server 4 via the network 3 as operated by the user.

The RDBMS server 4 is a server system equipped with an RDBMS 10 and is configured by including a CPU (Central Processing Unit) 11, a main storage device 12, a communications interface 13, an input device 14, and an output device 15.

The CPU 11 is a processor that controls the operation of the entire RDBMS server 4. Also, the main storage device 12 is composed of, for example, a volatile semiconductor memory and is mainly used to store and retain various kinds of software. Various processing is executed by the RDBMS server 4 as a whole as described later by the CPU executing the software stored in the main storage device 12. The RDBMS 10 is also stored and retained in this main storage device 12.

The communications interface 13 is an interface for protocol control during communications with the client 2, the secondary storage device 5, or the external data source 6 and is composed of, for example, an NIC (Network Interface Card).

The input device 14 is a device used by a system administrator or the like to perform various operations and is composed of, for example, a keyboard and a mouse. Also, the output device 15 is a device used to present various pieces of information to the system administrator and is composed of, for example, a liquid crystal monitor and a speaker.

The secondary storage device 5 is a mass storage system used to save various data managed by the RDBMS server 4 and is composed of, for example, hard disk drives and a RAID (Redundant Arrays of Independent Disks) system. The secondary storage device 5 stores an index 16 for a database managed by the RDBMS 10, tabular data 17 of tables managed by the RDBMS 10, threshold information 18 described later, and so on.

The external data source 6 is a program for managing and searching the non-structural data and, for example, a search engine or a graph database is applied.

### (1-2) Logical Structure of RDBMS

Next, the structure of the RDBMS 10 mounted in the RDBMS server 4 will be explained. Referring to FIG. 1, the RDBMS 10 according to this embodiment is configured by including a pre-processing unit 20, a query processing unit 21, a table function unit 22, a data management unit 23, a general control unit 24, and a temporary table area 25.

The pre-processing unit 20 is a program having a function that compiles a query from the client 2. Furthermore, the query processing unit 21 is a program having a function that executes the query compiled by the pre-processing unit 20. When the query from the client 2, for example, as in a case of a cross search, requires search results of the external data source 6, the table function unit 22 is a program having a function that issues a search request to the external data source 6 in response to this query, acquiring the search results in response to the search request from the external data source 6, and registering it in a temporary table (not shown in the drawing) of the RDBMS 10. When the table function unit 22 acquires the search results from the external data source 6, it also acquires the number of the search results (hereinafter simply referred to as the “search result count”).

The data management unit 23 is a program that has a function managing the tables managed by the RDBMS 10; and the general control unit 24 is a program that has a function controlling the pre-processing unit 20, the query processing unit 21, the table function unit 22, and the data management unit 23. Incidentally, the temporary table area 25 is a storage area for storing the temporary table which stores the search results of the external data source 6.

Under this circumstance, the pre-processing unit 20 is configured of: a query analyzer 30 for analyzing a query from the client 2; a query optimization unit 31 for optimizing the query analyzed by the query analyzer 30; and a query plan generator 32 for generating a plan 33 for processing on the query.

Furthermore, the query processing unit 21 is configured of: an insertion processing unit 40 for inserting data into a table managed by the RDBMS 10; an update processing unit 41 for updating the table managed by the RDBMS 10; a deletion processing unit 42 for deleting data from the table managed by the RDBMS 10; a search processing unit 43 for searching the table managed by the RDBMS 10 for data which satisfy designated conditions; a joining processing unit 44 for joining tables managed by the RDBMS 10, joining a table managed by the RDBMS 10 and the search result of the external data source 6, or joining the search results of the external data source 6 in response to, for example, a request from the client 2; and a query processing control unit 45 for analyzing a plan generated by the query plan generator 23 and invoking the relevant insertion processing unit 40, update processing unit 41, deletion processing unit 42, search processing unit 43, or joining processing unit 44 according to the content of the query.

Then, when the query from the client 2 is a join query to join the table of the RDBMS 10 and the temporary table which stores the search result of the external data source 6 (that is, a cross search), the joining processing unit 44 for the query processing unit 21 uses a Nested-Loop joining method to execute joining processing on the table managed by the RDBMS 10 with respect to each one search result of the external data source 6 registered in the temporary table. Moreover, when the joining processing unit 44 is activated, it also activates the table function unit 22. Consequently, the joining processing and the processing of the table function unit 22 are executed in parallel.

Furthermore, the joining processing unit 44 continues the processing until the joining processing on all the search results of the external data source 6 terminates. Under this circumstance, every time the joining processing unit 44 executes the joining processing on one search result of the external data source 6 registered in the temporary table and the table managed by the RDBMS 10, it calculates a remaining quantity of data of the temporary table on which the joining processing should be executed (hereinafter referred to as the “remaining join quantity”). At the same time, the joining processing unit 44 makes a query to the table function unit 22 about the search result count of the external data source 6 and then calculates a progress rate of the joining processing based on the thus-acquired search result count. Then, when the remaining join quantity is equal to or more than a predetermined threshold (hereinafter referred to as the “remaining join quantity threshold”) and the progress rate of the joining processing is less than a predetermined threshold (hereinafter referred to as the “progress rate threshold”), the joining processing unit 44 switches the joining method to a hash joining method, whose joining processing speed is faster than that of the Nested-Loop joining method, and then executes the remaining joining processing.

### (1-3) Details of Joining Processing According to this Embodiment

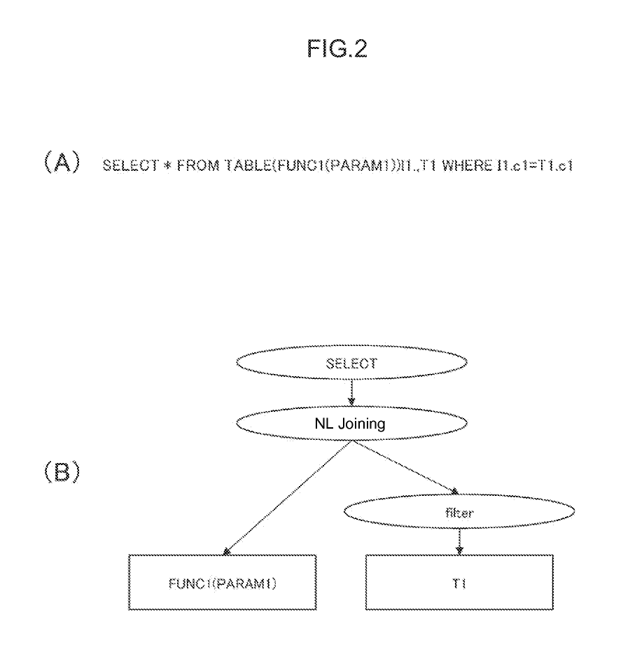

Next, the details of the joining processing according to this embodiment described above will be explained. In this section, an explanation will be given about a case where the RDBMS server 4 receives a join query, like the one illustrated in FIG. 2(A), which has been transmitted from the client 2. Incidentally, the join query in FIG. 2(A) is a join query (cross search request) that issues a search request to the external data source 6 by using a table function “FUNGI,” receives a search result of that search request, and requests joining of table “T1” managed by the RDBMS 10. Incidentally, “PARAM1” in parentheses of “FUNGI” represents an argument of the table function.

When the RDBMS server 4 receives the join query, the general control unit 24 for the RDBMS server 4 invokes the pre-processing unit 20. When the pre-processing unit 20 is invoked by the general control unit 24, it has the query analyzer 30 compile the join query, has the query optimization unit 31 optimize the compiled join query, and then has the query plan generator 32 generate a plan 33 which is the plan used when executing the optimized join query. Specifically speaking, the query plan generator 32 generates the plan 33 as illustrated in FIG. 2(B) to perform Nested-Loop joining between the search result of the table function “FUNC1(PARAM)” and data which satisfy conditions in the table “T1” managed by the RDBMS 10.

Subsequently, when the general control unit 24 receives a query execution request from the client 2, it invokes the query processing unit 21. Then, the query processing unit 21 has the query processing control unit 45 analyze the plan 33 in FIG. 2(B) and the query processing control unit 45 invokes a necessary function (the insertion processing unit 40, the update processing unit 41, the deletion processing unit 42, the search processing unit 43, or the joining processing unit 44) of the query processing unit to execute the plan 33.

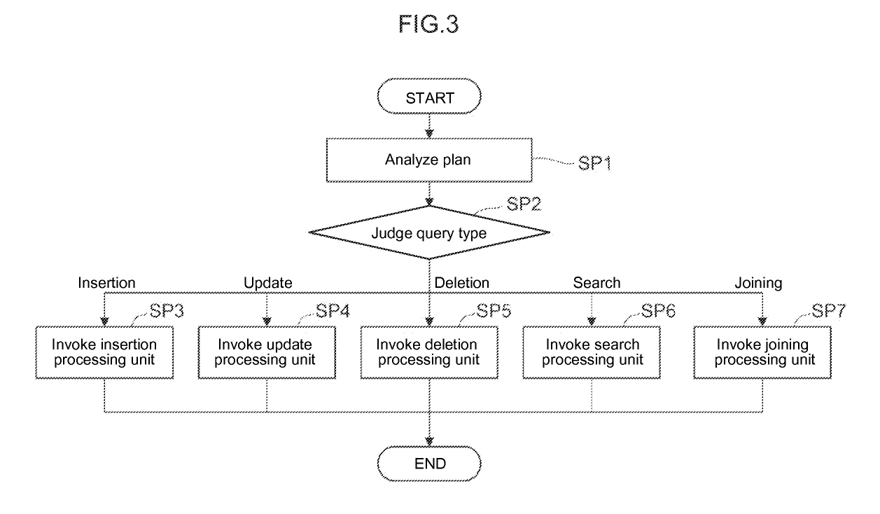

FIG. 3 illustrates specific processing content of the above-described processing (query execution control processing) executed by the query processing control unit 45. When the query processing unit 21 is invoked by the general control unit 24, the query processing control unit 45 starts this query execution control processing, firstly analyzes the plan 33 generated by the query plan generator 32 for the pre-processing unit 20 (SP1), and determines the type of the query whose execution is requested by the query execution request from the client 2, based on the analysis result (SP2).

Then, if the query processing control unit 45 determines that the query execution request requests for data insertion into the table of the RDBMS 10, it invokes the insertion processing unit 40 (SP3); and if the query processing control unit 45 determines that the query execution request requests for an update of the table of the RDBMS 10, it invokes the update processing unit 41 (SP4).

Moreover, if the query execution processing is to request deletion of data from the table of the RDBMS 10, the query processing control unit 45 invokes the deletion processing unit 42 (SP5); and if it is determined that the query execution request is to request a data search, the query processing control unit 45 invokes the search processing unit 43 (SP6).

Furthermore, if the query execution request is to request joining between, for example, the table of the RDBMS 10 and the search result of the external data source 6, the query processing control unit 45 invokes the joining processing unit 44 (SP7). Then, the query processing control unit 45 invokes the insertion processing unit 40, the update processing unit 41, the deletion processing unit 42, the search processing unit 43, or the joining processing unit 44 as described above.

Accordingly, when the query sent from the client 2 to the RDBMS server 4 is a join query like the one as illustrated in FIG. 2(A) and the plan 33 generated by the query plan generator based on this join query is a plan like the one illustrated in FIG. 2(B), this plan 33 includes Nested-Loop joining, so that the joining processing unit 44 is invoked by the query processing control unit 45 during the aforementioned query execution control processing.

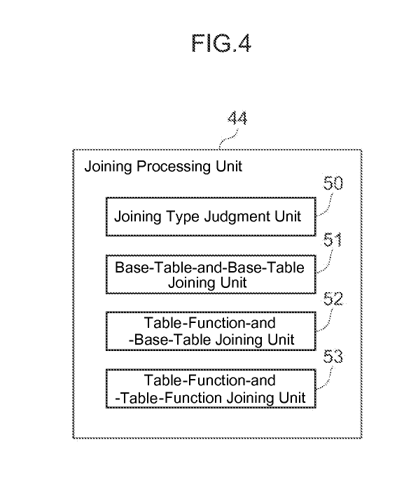

FIG. 4 illustrates the configuration of the joining processing unit 44. The joining processing unit 44 is configured of: a joining type determination unit 50 for determining the type of joining targets designated by the query execution request from the client 2 (joining between tables managed by the RDBMS 10, between a table managed by the RDBMS 10 and a search result of the external data source 6, or between search results of the external data source 6); a base-table-and-base-table joining unit 51 having a function that executes the processing for joining the tables managed by the RDBMS 10; a table-function-and-base-table joining unit 52 having a function that executes the processing for joining the table managed by the RDBMS 10 and the search result of the external data source 6; and a table-function-and-table-function joining unit 53 having a function that executes the processing for joining the search results of the external data source 6.

Then, when the joining processing unit 44 is invoked in step SP7 of the query execution control processing described above with reference to FIG. 3, it has the joining type determination unit 50 determine the joining target type. Then, if the type of the joining processing is determined to be joining between the tables of the RDBMS 10, the joining processing unit 44 invokes the base-table-and-base-table joining unit 51; if the type of the joining processing is determined to be joining between the table of the RDBMS 10 and the search result of the external data source 6, the joining processing unit 44 invokes the table-function-and-base-table joining unit 52; and if the type of the joining processing is determined to be joining between the search results of the external data source 6, the joining processing unit 44 invokes the table-function-and-table-function joining unit 53. Accordingly, in the example illustrated in FIGS. 2(A) and 2(B), the joining processing type is joining between the table of the RDBMS 10 and the search result of the external data source 6, so that the table-function-and-base-table joining unit 52 will be invoked. Incidentally, since the content of the joining processing by the base-table-and-base-table joining unit 51 and the content of the joining processing by the table-function-and-table-function joining unit 53 are the same as the existing RDBMS 10, an explanation about them has been omitted here.

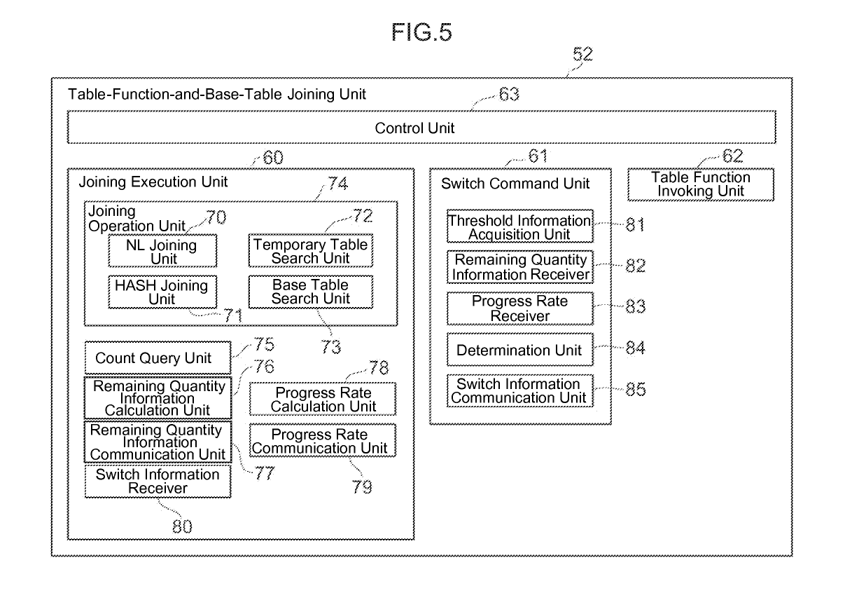

FIG. 5 illustrates the configuration of the table-function-and-base-table joining unit 52 described above with reference to FIG. 4. As illustrated in this FIG. 5, the table-function-and-base-table joining unit 52 is configured of: a joining execution unit 60 for executing the processing for joining the table managed by the RDBMS 10 and the search result of the external data source 6; a switch command unit 61 for giving a command to the joining execution unit 60 to switch the joining method from the Nested-Loop joining method to the hash joining method when necessary; a table function invoking unit 62 for invoking the table function unit 22 (FIG. 1) when necessary; and a control unit 63 for activating the joining execution unit 60, the switch command unit 61, and the table function invoking unit 62 when executing the join query.

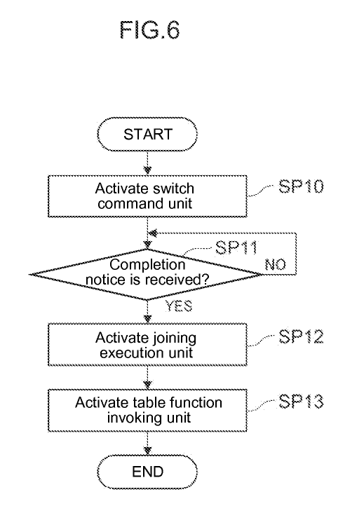

FIG. 6 illustrates the processing content of the activation processing executed by the control unit 63 for the table-function-and-base-table joining unit 52 when the joining processing unit 44 is invoked by the query processing control unit 45 in step SP7 of the query execution control processing (FIG. 3) described earlier in the example of FIGS. 2(A) and 2(B) and the table-function-and-base-table joining unit 52 is further invoked by the joining type determination unit 50 for the joining processing unit 44.

When the table-function-and-base-table joining unit 52 is invoked in step SP7 of the query execution control processing, the control unit 63 starts the activation processing illustrated in FIG. 6 and firstly activates the switch command unit 61 (SP10).

Subsequently, the control unit 63 waits for an activation completion notice (hereinafter referred to as the “activation completion notice”) to be transmitted from the switch command unit 61 (SP11); after eventually receiving the activation completion notice, the control unit 63 sequentially invokes the joining execution unit 60 and the table function invoking unit 62 (SP12, SP13) and then terminates this activation processing.

Meanwhile, the joining execution unit 60 which is activated by the control unit 63 in step SP12 of the activation processing (FIG. 6) acquires data, one by one, from the temporary table, which stores the search results of the external data source 6, and executes processing for joining the acquired data and the table which is a joining target and is managed by the RDBMS 10.

As means for executing such joining processing, the joining execution unit 60 includes a joining operation unit 74 configured of: a Nested-Loop joining unit 70 for executing processing for joining the joining targets (between the tables managed by the RDBMS 10, between the table managed by the RDBMS 10 and the search result of the external data source 6 or between the search results of the external data source 6) as illustrated in FIG. 5 by the Nested-Loop joining method; a hash joining unit 71 for executing processing for joining these joining targets by the hash joining method; a temporary table search unit 72 for searching the temporary table, which stores the search results of the external data source 6, for data and acquiring the data; and a base table search unit 73 for searching the table managed by the RDBMS 10 and acquiring data from that table.

Furthermore, the joining execution unit 60 includes: a count query unit 75 for acquiring the search result count of the external data source 6 from the table function unit 22 (FIG. 1); a remaining quantity information calculation unit 76 for calculating the remaining quantity of the joining processing (remaining join quantity); a remaining quantity information communication unit 77 for reporting the remaining join quantity calculated by the remaining quantity information calculation unit 76 to the switch command unit 61; a progress rate calculation unit 78 for calculating a progress rate of the joining processing based on the search result count of the external data source 6 which is acquired from the table function unit 22; a progress rate communication unit 79 for reporting the progress rate of the joining processing calculated by the progress rate calculation unit 78 to the switch command unit 61; and a switch receiver 80 for receiving a joining method switching command from the switch command unit 61.

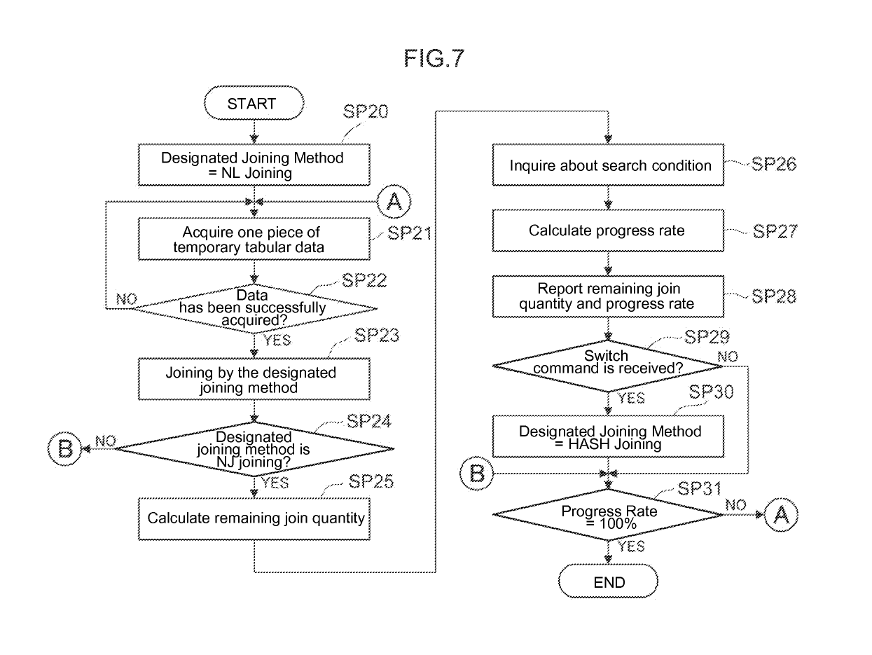

FIG. 7 illustrates the procedure of the joining execution unit 60 having the above-described configuration. The joining execution unit 60 executes the processing for joining the search result of the external data source 6 and the table managed by the RDBMS 10 in accordance with the procedure illustrated in this FIG. 6.

Practically, when the joining execution unit 60 is activated by the control unit 63 in step SP12 of the activation processing described above with reference to FIG. 6, it starts the joining processing in FIG. 7 and firstly designates the Nested-Loop joining method as the joining method to be used for the joining processing to be executed thereafter (SP20).

Next, the joining execution unit 60: acquires one piece of data from the temporary table which stores data of the joining target stored in the temporary table area 25 (FIG. 1) by the temporary table search unit 72 (SP21); and determines whether that data has been acquired successfully or not (SP22).

Obtaining a negative result in this judgment means that the search result by the search processing on the external data source 6, which is being executed in parallel processing, has not been registered in the temporary table, yet. Therefore, when this happens, the joining execution unit 60 returns to step SP21 and then repeats a loop of step SP21, and then step SP22, and back to step SP21 until the temporary table search unit 72 successfully acquires the data from the temporary table.

Then, if the joining execution unit 60 obtains an affirmative result in step SP22 as the temporary table search unit 72 eventually acquires one piece of data from the temporary table, it joins this data and the joining target table managed by the RDBMS 10 from the base table search unit 73 by the then-designated joining method (hereinafter referred to as the “designated joining method”) (SP23).

Subsequently, the joining execution unit 60 determines whether the current designated joining method is Nested-Loop joining or not (SP24); and if the joining execution unit 60 obtains a negative result, it proceeds to step SP31. Meanwhile, if the joining execution unit 60 obtains an affirmative result in the judgment of step SP24, it has the remaining quantity information calculation unit 76 calculate the remaining join quantity (SP25). Specifically speaking, the remaining quantity information calculation unit 76 calculates the remaining join quantity by subtracting the number of pieces of data, on which the joining processing has already been executed, from the number of pieces of data registered in the temporary table.

Then, the joining execution unit 60 has the count query unit 75 make a query to the table function unit 22 about the search result count of the external data source 6 (SP26) and has the progress rate calculation unit 78 calculate the progress rate of the joining processing based on the thus-acquired search result count of the external data source 6 (SP27). Specifically speaking, the progress rate calculation unit 78 calculates the progress rate of the joining processing by dividing the number of pieces of data, on which the joining processing has already been executed, among the data registered in the temporary table by the search result count of the external data source 6 acquired in step SP26.

Furthermore, the joining execution unit 60 has the remaining quantity information communication unit 77 report the remaining join quantity, which was calculated in step SP25, to the switch command unit 61 and also has the progress rate communication unit 79 report the progress rate, which was calculated in step SP27, to the switch command unit 61 (SP28), and then determines whether the switch receiver 80 has received a command, which is transmitted from the switch command unit 29 when necessary as described later, to switch the designated joining method to the hash joining method (hereinafter referred to as the “switch command”) or not (SP29).

Then, if the switch receiver 80 has not received the switch command from the switch receiver 80, the joining execution unit 60 proceeds to step SP31. Meanwhile, if the switch receiver 80 has received the switch command, the joining execution unit 60 switches the designated joining method to the hash joining method (SP30). Furthermore, the joining execution unit 60 then determines whether the progress rate calculated in step SP27 is 100% or not (SP31).

If the joining execution unit 60 obtains a negative result in this judgment, it returns to step SP21 and then repeats the processing from step SP21 to step SP31 while switching the data to be acquired from the temporary table in step SP21 sequentially from one data to another.

Then, if the joining execution unit 60 obtains an affirmative result in step SP31 as the progress rate of the joining processing becomes 100%, it terminates this joining execution processing.

Meanwhile, the switch command unit 61 activated by the control unit 63 in step SP10 of the activation processing described earlier with reference to FIG. 6 determines whether it is necessary to switch the joining method or not, based on the remaining join quantity and the progress rate supplied from the joining execution unit 60 every time the processing is executed for joining one piece of data stored in the temporary table and the joining target table of the RDBMS 10 as mentioned above; and the switch command unit 61 reports the judgment result to the joining execution unit 60.

As means for the above-described purpose, the switch command unit 61 includes, as illustrated in FIG. 5: a threshold information acquisition unit 81 for acquiring threshold information 18 (FIG. 1) stored in the secondary storage device 5; a remaining quantity information receiver 82 for receiving the aforementioned remaining join quantity transmitted from the joining execution unit 60; a progress rate receiver 83 for receiving the aforementioned progress rate transmitted from the joining execution unit 60; a determination unit 84 for determining whether it is necessary to switch the designated joining method or not by comparing the threshold information 18 acquired by the threshold information acquisition unit 81 with the remaining join quantity received by the remaining quantity information receiver 82 and the progress rate received by the progress rate receiver 83; and a switch information communication unit 85 for reporting the result of judgment by the determination unit 84 as switching information to the joining execution unit 60.

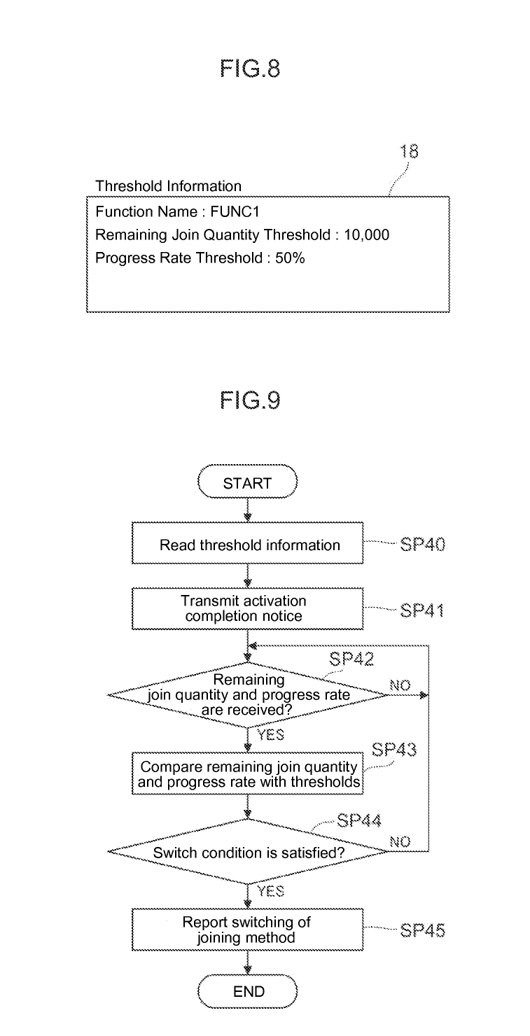

Under this circumstance, the threshold information 18 stored in the secondary storage device 5 is composed of information representing a function name, a remaining join quantity threshold, and a progress rate threshold, respectively, as indicated in FIG. 8. Among these pieces of information, the function name represents the name of a table function which issues a search request to the external data source 6; the remaining join quantity threshold represents a threshold value of the remaining join quantity; and the progress rate threshold represents a threshold value of the progress rate. When the remaining join quantity found during the joining processing is equal to or more than the remaining join quantity threshold and the progress rate of the joining processing is less than the progress rate threshold, the switch command unit 61: determines that it is necessary to switch the joining method; and then gives a command to the joining execution unit 60 to switch the joining method.

FIG. 9 illustrates a procedure of switch command processing executed by the switch command unit 61 as described above. The switch command unit 61 determines whether it is necessary to switch the joining method or not, in accordance with the procedure illustrated in this FIG. 9; and if it is necessary to switch the joining method, the switch command unit 61 gives a command to the joining execution unit 60 to switch the joining method.

Practically, when the switch command unit 61 is activated by the control unit 63 in step SP10 of the activation processing described earlier with reference to FIG. 6, it starts the switch command processing illustrated in this FIG. 9 and firstly has the threshold information acquisition unit 81 read and thereby acquire the threshold information 18, which is stored in the secondary storage device 5, from the secondary storage device 5 (SP40).

Subsequently, the switch command unit 61 reports the activation completion notice to the control unit 63 (SP41) and then wait for the remaining quantity information receiver 82 and the progress rate receiver 83 to receive the corresponding remaining join quantity and progress rate, respectively, from the joining execution unit 60 (SP42).

Then, if the switch command unit 61 obtains an affirmative result in step SP42 as the remaining quantity information receiver 82 and the progress rate receiver 83 eventually receive the remaining join quantity and the progress rate, respectively, it compares the received remaining join quantity and progress rate with their corresponding remaining join quantity threshold and progress rate threshold of the threshold information 18 (SP43).

Next, as a result of the comparison in step SP42, the switch command unit 61 has the determination unit 84 determine whether or not the remaining join quantity is equal to or more than the remaining join quantity threshold and the progress rate is less than the progress rate threshold (SP44). Then, if the switch command unit 61 obtains a negative result in this judgment, it returns to step SP42 and then waits for the next remaining join quantity and progress rate to be transmitted (SP42).

Meanwhile, if the switch command unit 61 obtains an affirmative result in the judgment of step SP44, it has the switch information communication unit 85 report the switch command to the joining execution unit 60 to switch the joining method (SP45) and then terminates this switch command processing.

Furthermore, the table function invoking unit 62 activated by the control unit 63 in step SP13 of the activation processing described earlier with reference to FIG. 6 executes processing for invoking the table function unit 22.

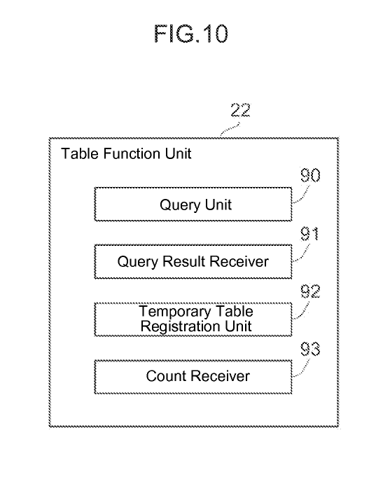

Under this circumstance, the table function unit 22 includes, as illustrated in FIG. 10: a query unit 90 for issuing a query (search request) and a query for the search result count to the external data source 6; a query result receiver 91 for receiving the result of the query from the external data source 6 in response to the query; a temporary table registration unit 92 for registering the search result of the external data source 6 received by the query result receiver 91 in the temporary table of the RDBMS 10; and a count receiver 93 for receiving the search result count reported from the external data source 6 in response to the query for the search result count.

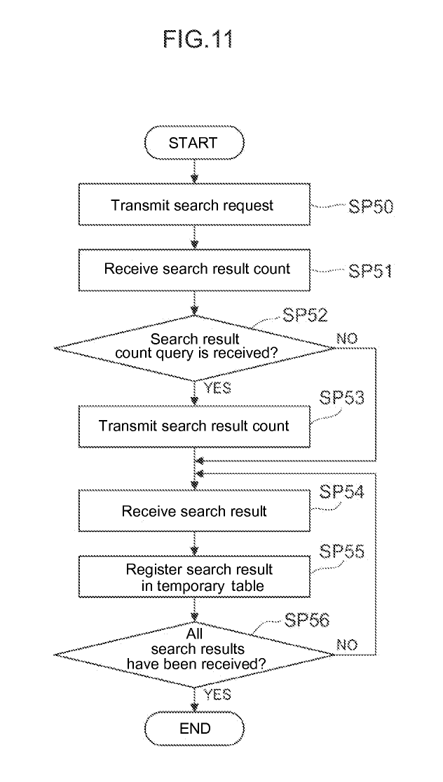

FIG. 11 illustrates a procedure of query processing executed by the table function unit 22 having the above-described configuration. When the table function invoking unit 62 is activated by the control unit 63 in step SP13 of the activation processing described earlier with reference to FIG. 6, it invokes the table function unit 22. Then, the table function unit 22 invoked by the table function invoking unit 62 executes the query processing for making a query to the external data source 6 about the search result count and the search result in accordance with the procedure illustrated in FIG. 11.

Practically, when the table function unit 22 is invoked by the function invoking unit 62, it starts the query processing illustrated in FIG. 11 and firstly transmits a search request from the query unit 90 to the external data source 6 in response to the join query from the client 2 (SP50).

Subsequently, the table function unit 22: has the count receiver 93 receive the search result count which is transmitted from the external data source 6 in response to the search request (SP51); and then determines whether the query about the search result count of the external data source 6 transmitted from the joining execution unit 60 (FIG. 5) has been received or not (SP52). Then, if the table function unit 22 obtains a negative result in this judgment, it proceeds to step SP54. On the other hand, if the table function unit 22 obtains an affirmative result, it transmits the search result count received in step SP51 to the joining execution unit 60 (SP53).

Next, the table function unit 22 has the query result receiver 91 receive the search result in response to the search request transmitted from the external data source 6 in step SP50 (SP54) and registers the received search result in the temporary table of the RDBMS 10 (SP55), and then determines whether it has finished receiving all the search results in response to the search request in step SP50 (SP56). Incidentally, this judgment is made by determining whether as many search results as the search result count received in step SP51 have been received or not, or by determining whether a request for termination of transfer of the search results has been received from the external data source or not.

Then, if the table function unit 22 obtains a negative result in this judgment, it returns to step SP54 and then repeats the processing from steps SP54 to step SP56. Then, if the table function unit 22 obtains an affirmative result in step SP56 by eventually receiving as many search results as the search result count received in step SP52, it terminates this query processing.

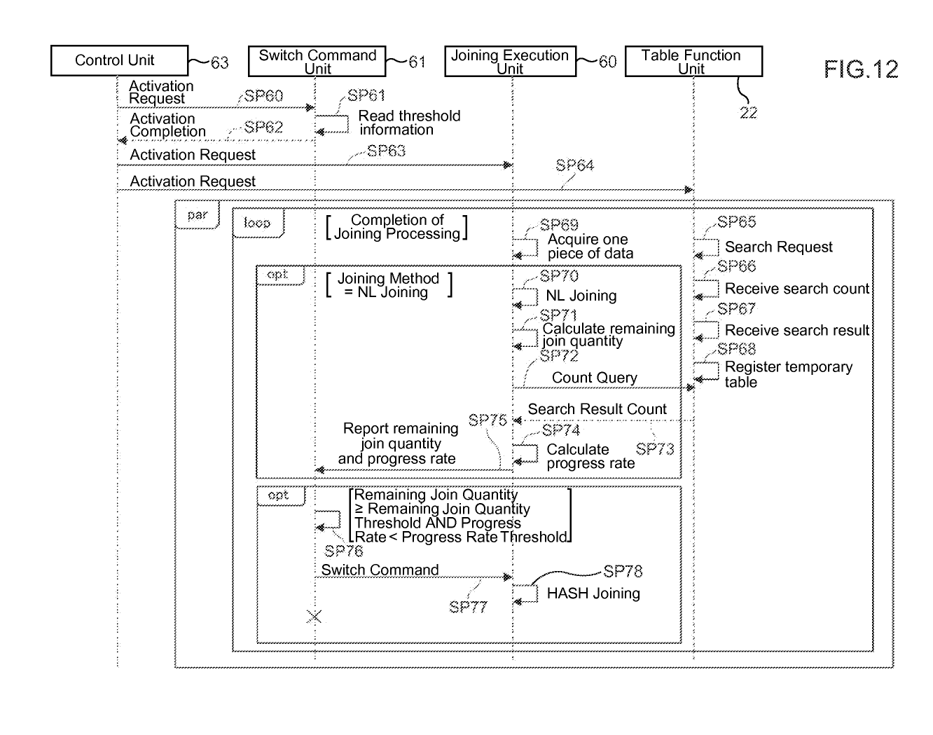

FIG. 12 illustrates an execution sequence of a join query according to this embodiment, which is executed by the table-function-and-base-table joining unit 52 and the table function unit 22 after compilation of the join query.

this execution sequence is started by activation of the table-function-and-base-table joining unit 52 (FIG. 5) for the joining processing unit 10 by the query processing control unit 45 (FIG. 1) for the query processing unit 21 (FIG. 1) when the RDBMS server 4 receives a join query (a cross search request in this example) transmitted from the client 2.

Then, when the table-function-and-base-table joining unit 52 is activated, the control unit 63 for the table-function-and-base-table joining unit 52 firstly transmits an activation request to the switch command unit 61 (SP60). Then, the switch control unit 61 which has received this activation request executes the activation processing, reads the threshold information 18 from the secondary storage device 5 (SP61), and then transmits an activation completion notice to the control unit 63 upon completion of the activation processing (SP62).

Furthermore, when the control unit 63 receives the activation completion notice from the switch command unit 61, it transmits an activation request to the joining execution unit 60 (SP63). Also at the same time, the control unit 63 transmits an activation request to the table function invoking unit 62. As a result, the table function unit 22 is invoked by the table function invoking unit 62 (SP64).

Then, the table function unit 22 invoked by the table function invoking unit 62 transmits a search request to the external data source 6 in response to the join query from the client 2 (SP65). Subsequently, when the table function unit 22 receives the search result count and the search result, respectively, transmitted from the external data source 6 in response to this search request (SP66, SP67), it registers the received search result in the temporary table of the RDBMS 10 (SP68).

Moreover, when the activation processing is completed, the joining execution unit 60 which has received the aforementioned activation request transmitted from the control unit 63 reads one piece of data from the temporary table of the RDBMS 10 (SP69) and joins the read data and the table managed by the RDBMS 10 by the Nested-Loop joining method (SP70). Then, the joining execution unit 60 calculates the current remaining join quantity with respect to the search results of the external data source 6 registered in the temporary table (SP71).

Furthermore, the joining execution unit 60 makes a query to the table function unit 22 about the search result count (SP72); and after the search result count is reported from the table function unit 22 (SP73), the joining execution unit 60 calculates the progress rate of the query based on the reported search result count (SP74). Then, the joining execution unit 60 reports the thus-calculated remaining join quantity and progress rate to the switch command unit 61 (SP75).

After receiving this remaining join quantity and the progress rate, the switch command unit 61 determines whether or not the remaining join quantity found during the joining processing is equal to or more than the remaining join quantity threshold and the progress rate of the joining processing is less than the progress rate threshold (SP76); and if the switch command unit 61 obtains an affirmative result in this judgment, it transmits a switch command to the joining execution unit 60 to switch the joining method (SP77).

Consequently, the joining execution unit 60 which has received this switch command switches the joining method used during the joining processing to the hash joining method (SP78) and then thereafter executes the processing for joining the search result of the external data source 6 and the table managed by the RDBMS 10 by the hash joining method.

### (1-4) Advantageous Effects of this Embodiment

Regarding the search system 1 according to this embodiment described above, when the client 2 makes a join query (cross search request) which requires to join the search result of the external data source 6 and the table managed by the RDBMS 10, whether the joining method is appropriate or not is determined every time the processing for joining one search result of the external data source 6 registered in the temporary table and the table managed by the RDBMS 10 is executed by the Nested-Loop joining method; and if it is determined that the joining method is not appropriate, the joining method is switched to the hash joining method and the remaining joining processing is then executed, so that the cross search can be processed at high speed.

Furthermore, since this search system 1 executes the joining processing upon execution of the cross search and the search processing on the external data source 6 in parallel, the speed of the cross search can be further increased.

### (2)) Second Embodiment

In the first embodiment, every time one piece of data in the temporary table, which stores the search results of the external data source 6, and the table managed by the RDBMS 10 are joined, the remaining join quantity and the progress rate of the joining processing are calculated, respectively, and whether the joining method should be switched or not is determined based on the remaining join quantity and the progress rate.

Meanwhile, this embodiment is characterized in that every time one piece of data in the temporary table, which stores the search results of the external data source 6, and the table managed by the RDBMS 10 are joined, not the remaining join quantity, but a hit rate and the progress rate of the joining processing are found and whether the joining method should be switched or not is determined based on the hit rate and the progress rate.

The hit rate used herein in this embodiment means a rate of data, which satisfy joining conditions, among the entire data of the joining target table managed by the RDBMS 10 with respect to the one piece of data, on which the joining processing is then executed, in the temporary table which stores the search results of the external data source 6.

### (2-1) Configuration of Search System According to this Embodiment

A search system according to this embodiment is configured in the same manner as the search system 1 according to the first embodiment, except that the configuration of the table-function-and-base-table joining unit 52 for the joining processing unit 44 described earlier with reference to FIG. 5 is different.

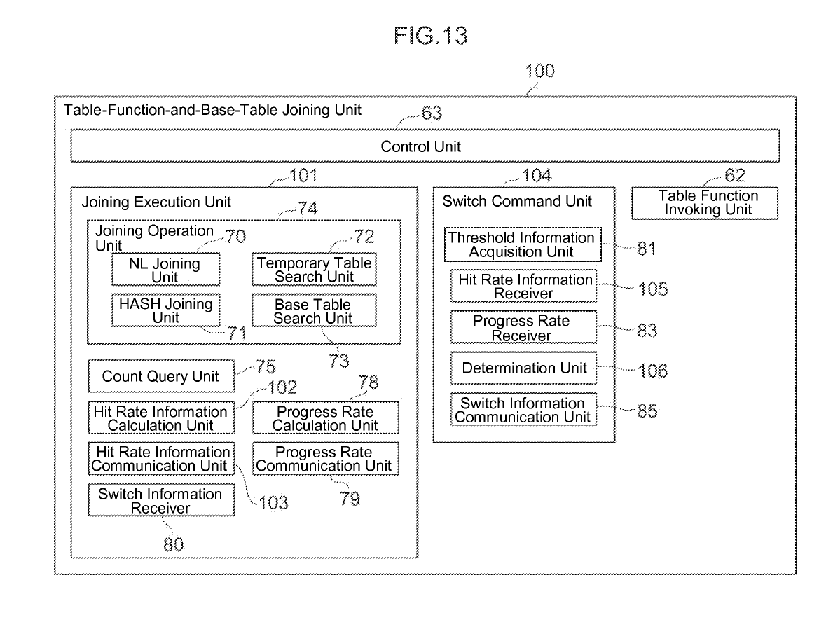

FIG. 13 which shows parts corresponding to FIG. 5 by assigning the same reference numerals to them illustrates the configuration of a table-function-and-base-table joining unit 100 according to this embodiment. A joining execution unit 101 for this table-function-and-base-table joining unit 100 is configured in the same manner as the joining execution unit 60 (FIG. 5) for the table-function-and-base-table joining unit 52 according to the first embodiment, except that a hit rate information calculation unit 102 and a hit rate information communication unit 103 are provided instead of the remaining quantity information calculation unit 76 (FIG. 5) and the remaining quantity information communication unit 77 (FIG. 5).

Under this circumstance, the hit rate information calculation unit 102 has a function calculating the hit rate of one piece of data in the temporary table which stores the search results of the external data source 6 every time the processing for joining the one piece of data and the joining target table managed by the RDBMS 10. Furthermore, the hit rate information communication unit 103 has a function reporting the hit rate calculated by the hit rate information calculation unit 102 to the switch command unit 104.

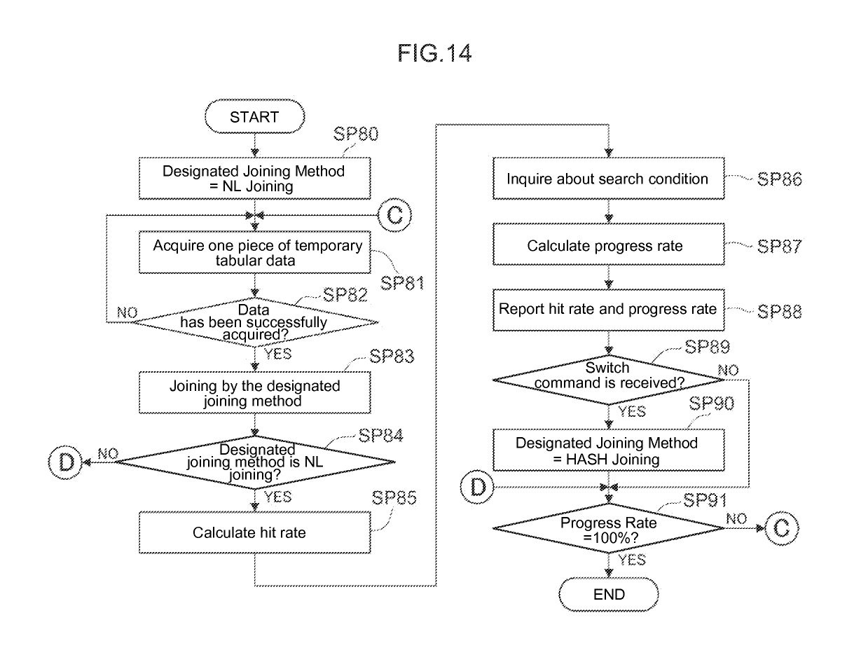

FIG. 14 illustrates a procedure of joining execution processing executed by the joining execution unit 101 according to this embodiment. The joining execution unit 101 joins the search result of the external data source 6 and the table managed by the RDBMS 10 based on the join query from the client 2 and in accordance with the procedure illustrated in this FIG. 14.

Practically, when the joining execution unit 101 is activated by the control unit 63 in step SP 12 of the activation processing described earlier with reference to FIG. 6, it starts the joining execution processing illustrated in this FIG. 14 and processes step SP80 to step SP84 in the same manner as in step SP20 to step SP24 of the joining processing of the first embodiment described earlier with reference to FIG. 7.

Subsequently, the joining execution unit 101 has the hit rate information calculation unit 102 calculate the hit rate of data which is a target at that time (SP85). Specifically speaking, the joining execution unit 101 calculates a rate of data, which satisfy the joining conditions, among data of the joining target table managed by the RDBMS 10 as the hit rate with respect to the data acquired in step SP81.

Next, the joining execution unit 101 processes step SP86 and step SP87 in the same manner as in step SP26 and step SP27 of the joining execution processing according to the first embodiment; and then has the hit rate information communication unit 103 report the hit rate calculated in step SP85 to the switch command unit 104 and also has the progress rate communication unit 79 report the progress rate calculated in step SP87 to the switch command unit 104 (SP88).

Then, the joining execution unit 101 processes step SP89 to step SP91 in the same manner as in step SP29 to step SP31 of the joining execution processing according to the first embodiment; and if the joining execution unit 101 eventually obtains an affirmative result in step SP91, it terminates this joining execution processing.

Meanwhile, the switch command unit 104 for the table-function-and-base-table joining unit 100 according to this embodiment is configured in the same manner as the switch command unit 61 (FIG. 5) according to the first embodiment, except that a hit rate information receiver 105 is provided instead of the remaining quantity information receiver 82 (FIG. 5) and a determination unit 106 determines whether it is necessary to switch the joining method or not, based on the hit rate reported from the joining execution unit 101.

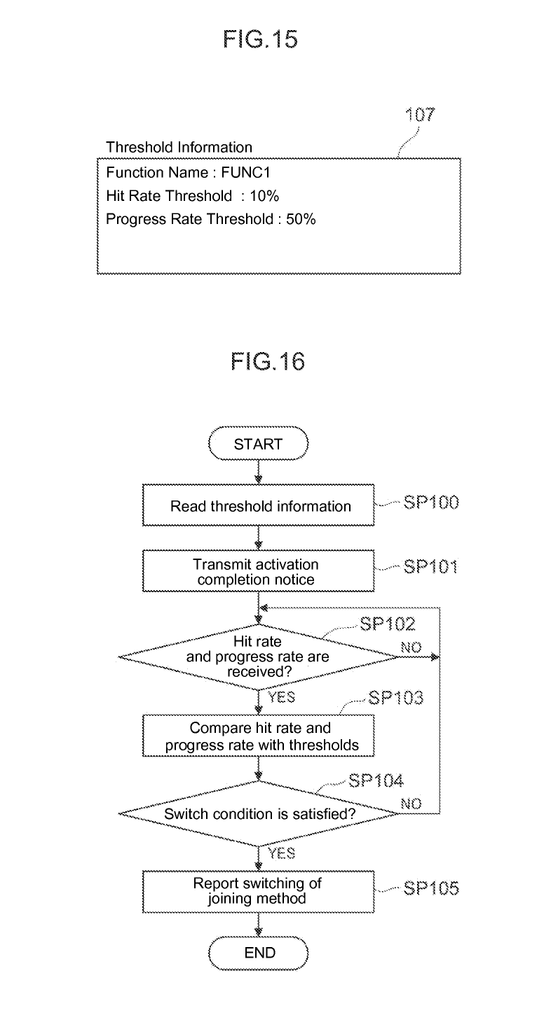

Furthermore, in the case of this embodiment, the secondary storage device 5 (FIG. 1) stores threshold information 107 as illustrated in FIG. 15 instead of the threshold information 18 according to the first embodiment described earlier with reference to FIG. 8. As is apparent from FIG. 15, the threshold information 107 according to this embodiment includes each piece of information about a function name, a hit rate threshold, and a progress rate threshold. Among these pieces of information, the function name represents the name of a table function which issues a search request to the external data source 6; the hit rate threshold represents a threshold value of the hit rate; and the progress rate threshold represents a threshold value of the progress rate. When the hit rate calculated during the joining processing is equal to or more than the hit rate threshold and the progress rate of the joining processing is less than the progress rate threshold, the switch command unit 104 determines that it is necessary to switch the joining method, and then instructs the joining execution unit 101 to switch the joining method.

FIG. 16 illustrates a procedure of switch command processing executed by the switch command unit 104 according to this embodiment described above. The switch command unit 104 determines whether it is necessary to switch the joining method or not, in accordance with the procedure illustrated in this FIG. 16; and when it is necessary to switch the joining method, the switch command unit 104 gives a command to the joining execution unit 101 to switch the joining method.

Practically, when the switch command unit 104 is activated by the control unit 63 in step SP10 of the activation processing described earlier with reference to FIG. 6, it starts the switch command processing illustrated in FIG. 16 and firstly has the threshold information acquisition unit 81 acquire the threshold information 107, which is stored in the secondary storage device 5, from the secondary storage device 5 (SP100).

Subsequently, the switch command unit 104 informs the control unit 63 of an activation completion notice to report the completion of activation (SP101) and then waits for the hit rate information receiver 105 and the progress rate receiver 83 to respectively receive the corresponding hit rate and progress rate to be transmitted from the joining execution unit 101 (SP102).

Then, if the switch command unit 104 obtains an affirmative result in step SP103 as the hit rate information receiver 105 and the progress rate receiver 83 eventually receive the hit rate and the progress rate respectively, it has the determination unit 106 compare the received hit rate and progress rate with the threshold information 107 acquired in step SP100 (SP103).

Subsequently, as a result of the comparison in step SP103, the switch command unit 104 has the determination unit 106 determine whether or not the hit rate is equal to or more than the hit rate threshold and the progress rate of the joining processing is less than the progress rate threshold (SP104). Then, if the switch command unit 104 obtains a negative result in this judgment, it returns to step SP102 and then waits for the next hit rate and progress rate to be transmitted.

On the other hand, if the switch command unit 104 obtains an affirmative result in the judgment of step SP104, it has the switch information communication unit 85 transmit a switch command to the joining execution unit 101 to switch the joining method (SP105) and then terminates this switch command processing.

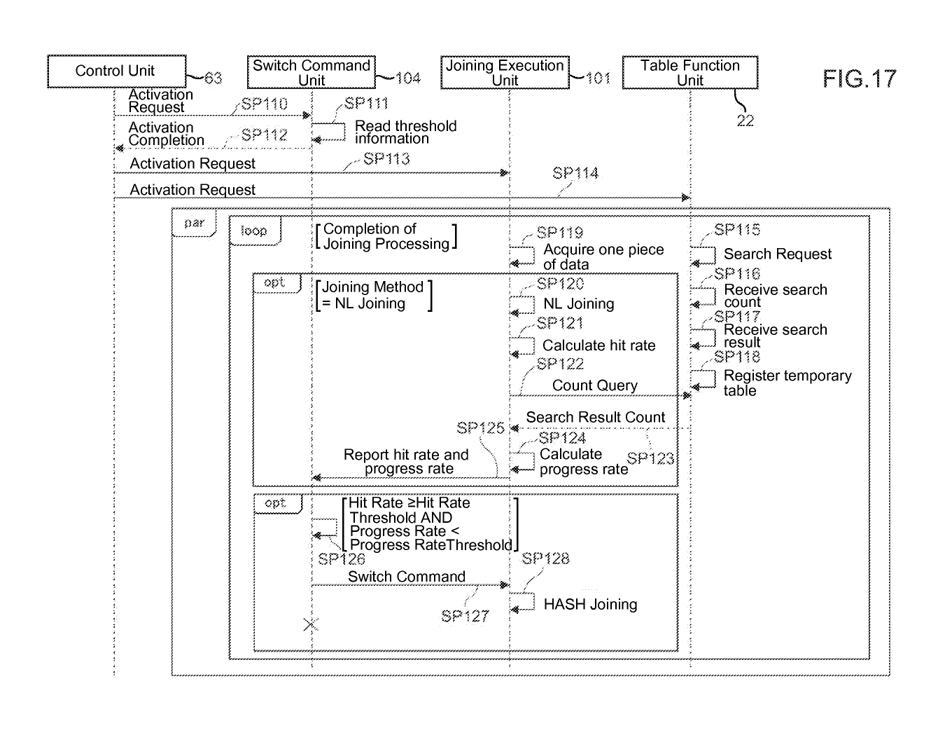

FIG. 17 illustrates an execution sequence of the join query according to this embodiment, which is executed by the table-function-and-base-table joining unit 100 and the table function unit 22 after compilation of the join query. Incidentally, this execution sequence is the same as the execution sequence of the first embodiment described earlier with reference to FIG. 12, except that the joining execution unit 101 calculates the hit rate in step SP121 and reports the calculated hit rate to the switch command unit 104 in step SP125 and the switch command unit 104 determines whether the joining method should be switched or not, based on the hit rate and the progress rate in step SP126. Therefore, a detailed explanation about it has been omitted here.

### (2-2) Advantageous Effects of this Embodiment

Regarding the search system according to this embodiment as described above, every time one piece of data in the temporary table, which stores the search results of the external data source 6, and the table managed by the RDBMS 10 are joined, the hit rate and the progress rate of the joining processing are calculated and whether the joining method should be switched or not is determined based on the hit rate and the progress rate; and if it is determined that the joining method is not appropriate, the joining direction is switched to the hash joining method and then the remaining joining processing is executed. Therefore, the cross search can be processed at high speed in the same manner as in the first embodiment.

### (3) Third Embodiment

this embodiment is characterized in that whether the joining method should be switched or not is determined based only on the remaining join quantity. Specifically speaking, every time one piece of data in the temporary table, which stores the search results of the external data source 6, and the table managed by the RDBMS 10 are joined, the remaining join quantity is calculated and whether the joining method should be switched or not is determined based on the calculated remaining join quantity.

### (3-1) Configuration of Search System According to this Embodiment

A search system according to this embodiment is configured in the same manner as the search system 1 according to the first embodiment, except that the configuration of the table-function-and-base-table joining unit 52 for the joining processing unit described earlier with reference to FIG. 5 and the configuration of the table function unit 22 described earlier with reference to FIG. 10 are different.

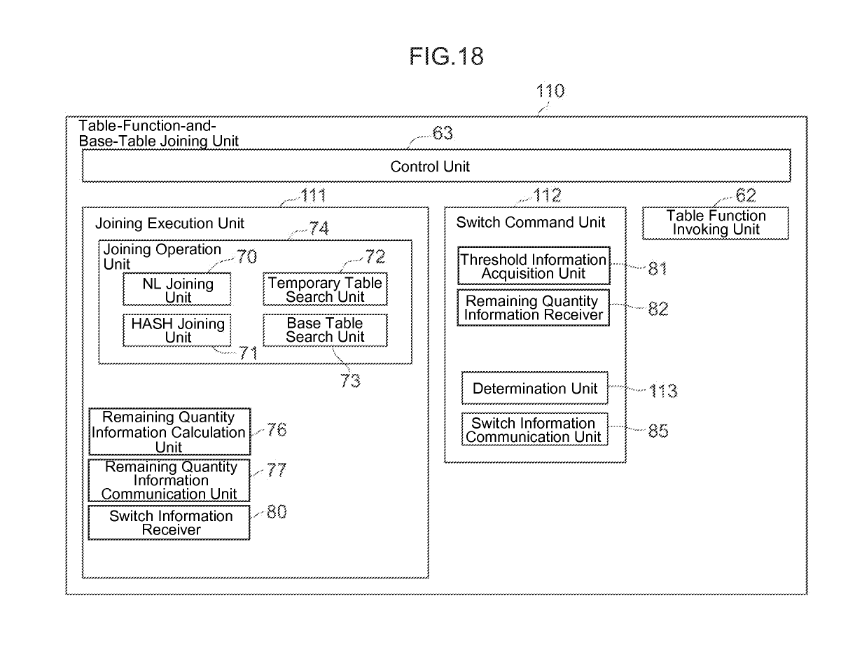

FIG. 18 which shows parts corresponding to FIG. 5 by assigning the same reference numerals to them illustrates the configuration of a table-function-and-base-table joining unit 110 according to this embodiment. Regarding this table-function-and-base-table joining unit 110, a joining execution unit 111 is configured in the same manner as the joining execution unit 60 for the table-function-and-base-table joining unit 52 according to the first embodiment, except that it does not include the count query unit 75 (FIG. 5), the progress rate calculation unit 78 (FIG. 5), and the progress rate communication unit 79 (FIG. 5).

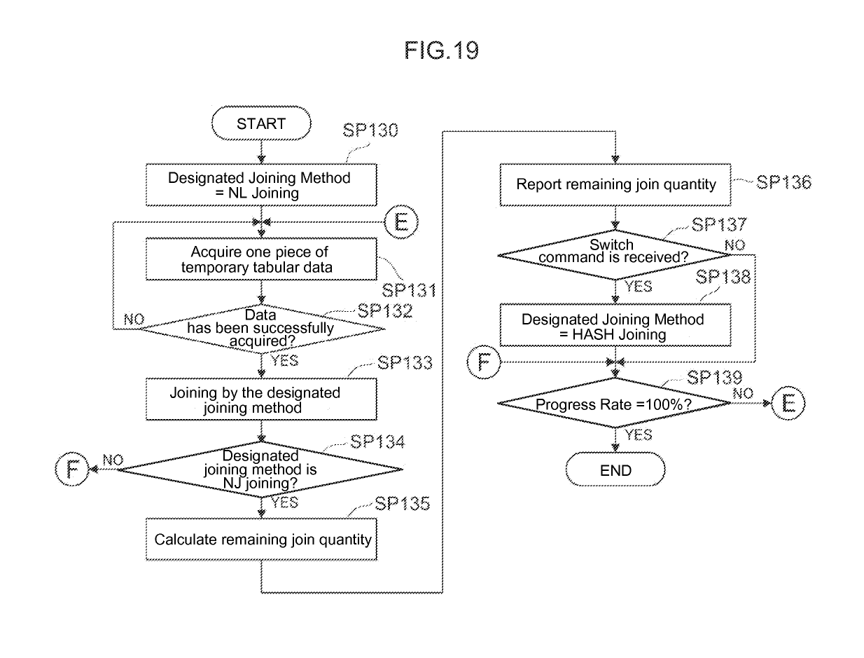

FIG. 19 illustrates a procedure of joining execution processing executed by the joining execution unit 111 according to this embodiment. The joining execution unit 111 joins the search result of the external data source 6 and the table managed by the RDBMS 10 based on the join query from the client 2 and in accordance with the procedure illustrated in this FIG. 19.

Practically, when the joining execution unit 111 is activated by the control unit 63 in step SP13 of the activation processing described earlier with reference to FIG. 6, it starts the joining execution processing illustrated in this FIG. 19 and processes step SP130 to step SP135 in the same manner as in step SP20 to step SP24 of the joining processing of the first embodiment described earlier with reference to FIG. 7.

Subsequently, the joining execution unit 111 has the remaining quantity information communication unit 77 report the remaining join quantity calculated in step SP135 to the switch command unit 112 (SP136). How to calculate the remaining join quantity here is the same as the first embodiment.

Then, the joining execution unit 111 processes step SP137 to step SP139 in the same manner as in step SP29 to step SP31 of the joining execution processing according to the first embodiment; and if the joining execution unit 111 obtains an affirmative result in step SP139, it terminates this joining execution processing.

Meanwhile, the switch command unit 112 for the table-function-and-base-table joining unit 110 according to this embodiment is configured in the same manner as the switch command unit 61 (FIG. 5) according to the first embodiment, except that the switch command unit 112 for the table-function-and-base-table joining unit 110 according to this embodiment is not provided with the progress rate receiver 83 (FIG. 5) as illustrated in FIG. 18 and the determination unit 113 determines whether it is necessary to switch the joining method or not, based only on the remaining join quantity.

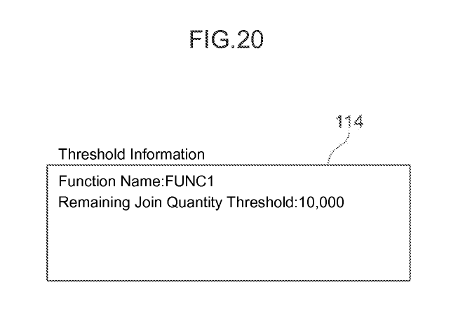

Furthermore, in the case of this embodiment, the secondary storage device 5 (FIG. 1) stores threshold information 114 as illustrated in FIG. 20 instead of the threshold information 18 according to the first embodiment described earlier with reference to FIG. 8. As is apparent from FIG. 20, this threshold information 114 includes each piece of information about a function name and a remaining join quantity threshold. Among these pieces of information, the function name represents the name of a table function which issues a search request to the external data source 6; and the remaining join quantity threshold represents a threshold value of the remaining join quantity. If the remaining join quantity calculated during the joining processing is equal to or more than the remaining join quantity threshold, the switch command unit 112 determines that it is necessary to switch the joining method, and then gives a command to the joining execution unit 111 to switch the joining method.

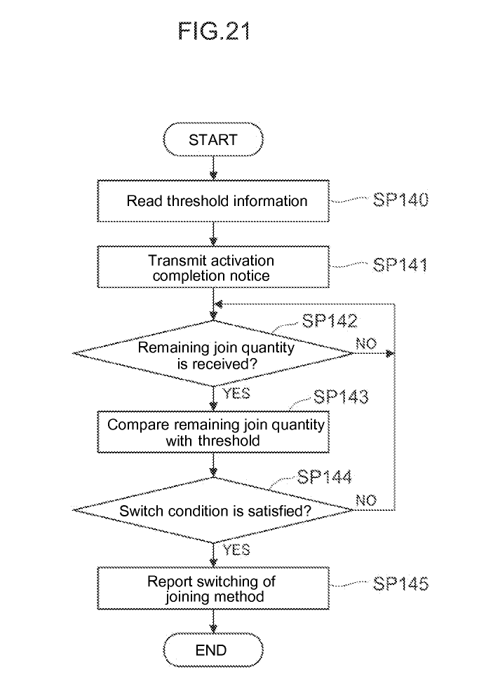

FIG. 21 illustrates a procedure of switch command processing executed by the switch command unit 112 according to this embodiment described above. The switch command unit 112 determines whether it is necessary to switch the joining method or not, in accordance with the procedure illustrated in this FIG. 21; and when it is necessary to switch the joining method, the switch command unit 112 gives a command to the joining execution unit 111 to switch the joining method.

Practically, when the switch command unit 112 is activated by the control unit 63 in step SP10 of the activation processing described earlier with reference to FIG. 6, it starts the switch command processing illustrated in this FIG. 21 and processes step SP140 and step SP141 in the same manner as in step SP40 and step SP41 of the switch command processing according to the first embodiment described earlier with reference to FIG. 9.

Subsequently, the switch command unit 112 waits for the remaining quantity information receiver 82 to receive the remaining join quantity transmitted from the joining execution unit 111 (SP142). Furthermore, if the switch command unit 112 obtains an affirmative result in step SP142 as the remaining quantity information receiver 82 eventually receives the remaining join quantity, it has the determination unit 113 compare the received remaining join quantity with the threshold information 114 (FIG. 20) (SP143).

Then, as a result of the comparison in step SP143, the switch command unit 112 has the determination unit 113 determine whether or not the remaining join quantity is equal to or more than the remaining join quantity threshold (SP144). Then, if the switch command unit 112 obtains a negative result in this judgment, it returns to step SP142 and then waits for the next remaining join quantity to be transmitted.

On the other hand, if the switch command unit 112 obtains an affirmative result in the judgment of step SP144, it has the switch information communication unit 85 transmit a switch command to the joining execution unit 111 to switch the joining method (SP145) and then terminates this switch command processing.

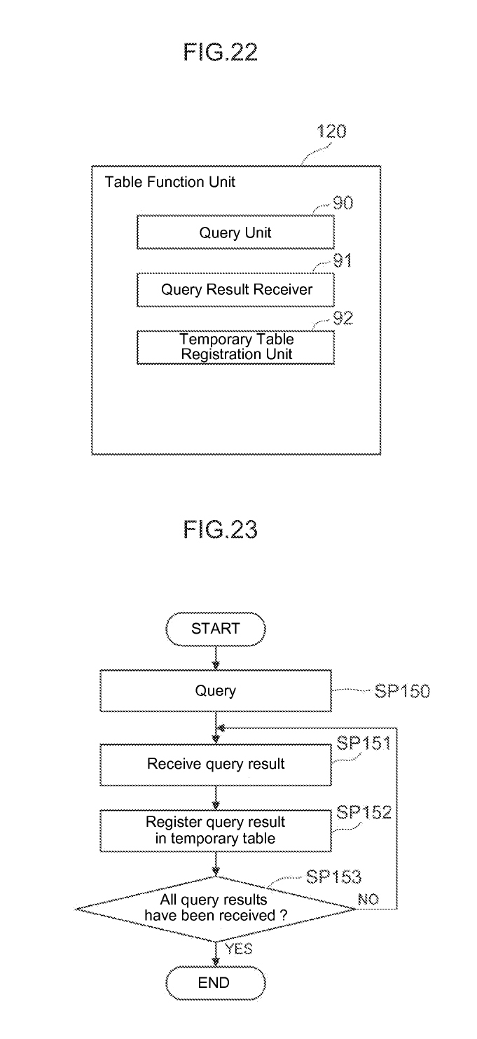

Furthermore, the table function unit 120 according to this embodiment is configured in the same manner as the table function unit 22 (FIG. 10) according to the first embodiment, except that the count receiver 93 (FIG. 10) for receiving the search result count reported from the external data source 6 in response to a query about the search result count is not provided as illustrated in FIG. 22.

FIG. 23 illustrates a procedure of query processing executed by the table function unit 120 having the above-described configuration. When the table function unit 120 is invoked by the table function invoking unit 62 activated by the control unit 63 in step SP13 of the activation processing described earlier with reference to FIG. 6, it starts the query processing illustrated in this FIG. 23 and firstly transmits a search request from the query unit 90 to the external data source 6 in response to the join query from the client 2 (SP150).

Then, the table function unit 120 processes step SP151 to step SP153 in the same manner as in step SP54 to step SP56 of the query processing according to the first embodiment described earlier with reference to FIG. 1 and thereby registers all the search results of the external data source 6 in the temporary table of the RDBMS 10, and then terminates this query processing.

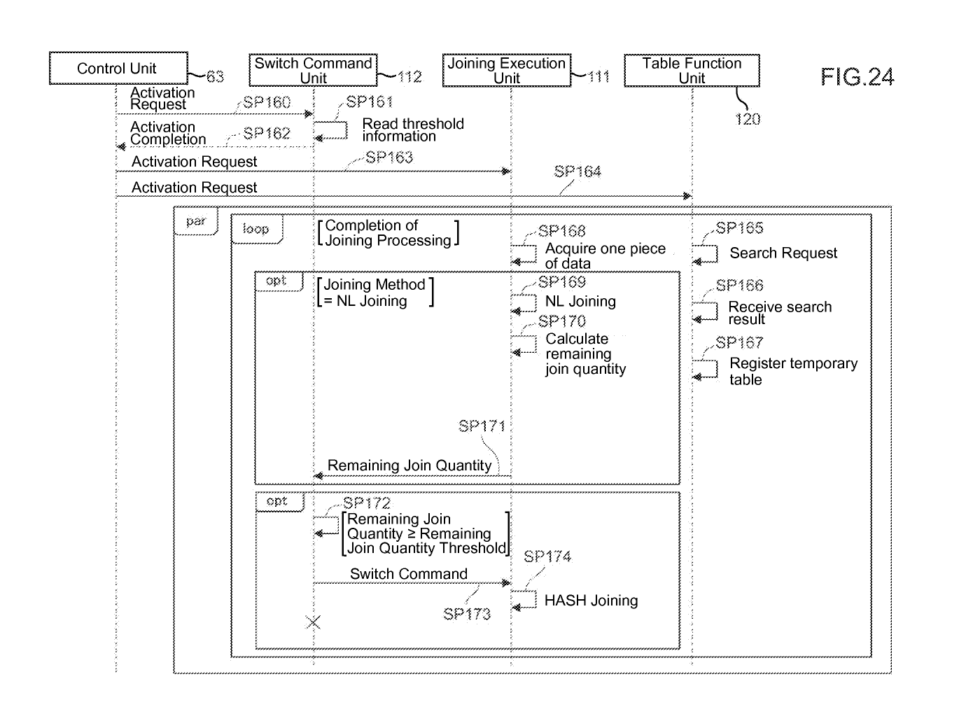

FIG. 24 illustrates an execution sequence of the join query according to this embodiment, which is executed by the table-function-and-base-table joining unit 52 and the table function unit 22 after compilation of the join query.

When the RDBMS server 4 receives the join query (cross search request in this example) transmitted from the client 2, this execution sequence is started by activation of the table-function-and-base-table joining unit 110 (FIG. 18) for the joining processing unit 10 by the query processing control unit 45 (FIG. 1) for the query processing unit 21 (FIG. 1).

Then, once the table-function-and-base-table joining unit 110 is activated, step SP160 to step SP164 are processed in the same manner as step SP60 to step SP64 of the execution sequence according to the first embodiment described earlier with reference to FIG. 12, thereby having the control unit 63 activate each of the switch command unit 112, the joining execution unit 111, and the table function unit 120.

Then, the table function unit 120 transmits a search request to the external data source 6 in response to the join query from the client 2 (SP165). Subsequently, when the table function unit 120 receives the search result transmitted from the external data source 6 in response to this search request (SP166), it registers the received search result in the temporary table of the RDBMS 10 (SP167).

Furthermore, when the activation processing is completed, the joining execution unit 111 activated by the control unit 63 reads one piece of data from the temporary table (SP168) and joins the read data and the table managed by the RDBMS 10 by the Nested-Loop joining method (SP169). Then, the joining execution unit 111 calculates the current remaining join quantity with respect to the search results of the external data source 6 registered in the temporary table (SP170) and reports the calculated remaining join quantity to the switch command unit 112 (SP171).

After receiving this remaining join quantity, the switch command unit 112 determines whether or not the remaining join quantity calculated during the joining processing is equal to or more than the remaining join quantity threshold (SP172); and if the switch command unit 112 obtains an affirmative result in this judgment, it transmits a switch command to the joining execution unit 111 to switch the joining method (SP173).

Consequently, the joining execution unit 111 which has received this switch command switches the joining method to be used for the joining processing to the hash joining method (SP174) and then executes the processing for joining the search result of the external data source 6 and the table managed by the RDBMS 10 by the hash joining method.

### (3-2) Advantageous Effects of this Embodiment

Regarding the search system according to this embodiment as described above, every time one piece of data in the temporary table, which stores the search results of the external data source 6, and the table managed by the RDBMS 10 are joined, the remaining join quantity is calculated and whether the joining method should be switched or not is determined based on the remaining join quantity; and if it is determined that the joining method is not appropriate, the joining direction is switched to the hash joining method and then the remaining joining processing is executed. Therefore, the cross search can be processed at high speed in the same manner as in the first embodiment even if the search result count cannot be acquired from the external data source 6.

### (4) Other Embodiments

Incidentally, the aforementioned first to third embodiments have described the case where the data management system is the RDBMS 10; however, the present invention is not limited to this example and a wide variety of other data management systems can be applied.

Furthermore, the aforementioned first to third embodiments have described the case where the joining methods applied to the processing for joining the search result of the external data source 6 and the table managed by the RDBMS 10 are the Nested-Loop joining method and the hash joining method; however, the present invention is not limited to this example and a wide variety of other joining methods can be applied. In this case, the processing for joining the search result of the external data source 6 and the table managed by the RDBMS 10 may be started by a first joining method and then the joining method may be switched to a second joining method, whose processing speed is faster than that of the first joining method, when the need arises.

Furthermore, the aforementioned first to third embodiments have described the case where the remaining join quantity and the progress rate of the joining processing, and the hit rate are applied when determining whether the joining method applied to the processing for joining the search result of the external data source 6 and the table managed by the RDBMS 10 is an appropriate joining method or not; however, the present invention is not limited to this example and a wide variety of information other than the remaining join quantity, the progress rate, and/or the hit rate (information acquired by the search processing on the external data source 6 and/or information found during the joining processing) can be applied. In this case, a standard for determining whether the joining method applied to the processing for joining the search result of the external data source 6 and the table managed by the RDBMS 10 is an appropriate joining method or not may be decided according to the information applied at that time.

Furthermore, the aforementioned first to third embodiments have described the case where a storage medium which is a semiconductor memory is applied as a storage medium for storing the RDBMS 10 to which the present invention is applied; however, the present invention is not limited to this example and it is possible to apply a wide variety of storage media, for example, disc-type storage media such as CDs (Compact Discs), DVDs (Digital Versatile Discs), BD (Blu-ray [registered trademark] Discs), hard disk drives, or optical discs, nonvolatile semiconductor memories, or other storage media.

### INDUSTRIAL APPLICABILITY

The present invention enables to be applied to a search system capable of conducting a cross search.

### REFERENCE SIGNS LIST

1 Search system; 2 client; 4 RDBMS server; 5 secondary storage device; 6 external data source; 11 CPU; 12 main storage device; 16, 107, 114 threshold information; 21 query processing unit; 22, 120 table function unit; 44 joining processing unit; 52, 100, 110 table-function-and-base-table joining unit; 63 control unit; 60, 101, 111 joining execution unit; 61, 104, 112 switch command unit; 62 table function invoking unit; 70 Nested-Loop joining unit; 71 hash joining unit; 73 base table search unit; 74 joining operation unit; 75 count query unit; 76 remaining quantity information calculation unit; 77 remaining quantity information communication unit; 78 progress rate calculation unit; 79 progress rate communication unit; 81 threshold information acquisition unit; 84, 113 determination unit; 90 query unit; 91 query result receiver; 92 temporary table registration unit; 93 count receiver; 102 hit rate information calculation unit; and 103 hit rate information communication unit.

1. A join execution method executed by a join query execution device for searching an external data source connected to a data management system by means of a table function and executing joining processing against a join query regarding a search result of the table function and a table managed by the data management system, wherein the join execution method comprising:
a first step, executed by the join query execution device, of executing the joining processing regarding the search result of the table function and the table managed by the data management system by a first joining method;
a second step, executed by the join query execution device, of determining whether the first joining method is an appropriate joining method as a joining method for the joining processing or not, by using information acquired by search processing on the external data source by means of the table function and/or information found during the joining processing; and
a third step, executed by the join query execution device, of regarding, in case it is determined that the first joining method is not the appropriate joining method as the joining method for the joining processing, a second joining method as the faster than the first joining method and switching the joining method for the joining processing from the first joining method to the second joining method.

2. The join query execution method according to claim 1,
wherein in the first step, the join query execution device executes the joining processing and the search processing on the external data source by means of the table function in parallel.

3. The join query execution method according to claim 1,
wherein the first joining method is a Nested-Loop joining method and the second joining method is a Hash joining method.

4. The join query execution method according to claim 1,
wherein in the second step, in case a search result count of the search processing can be acquired upon execution of the search processing on the external data source, the join query execution device acquires the search result count and determines whether the first joining method is the appropriate joining method as the joining method for the joining processing or not, by using the acquired search result count and the information found during the joining processing; and
wherein in the second step, when the search result count of the search processing cannot be acquired upon execution of the search processing on the external data source, the join query execution device determines whether the first joining method is the appropriate joining method as the joining method for the joining processing or not, by using only the information found during the joining processing.

5. The join query execution method according to claim 4,
wherein in the second step, when the search result count of the search processing can be acquired upon execution of the search processing on the external data source,
the join query execution device:
acquires the search result count;
calculates a progress of the joining processing and remaining quantity of the joining processing by using the search result count of the external data source every time the joining processing is executed on one search result of the external data source and the table managed by the data management system; and
determines whether the Nested-Loop joining method is the appropriate joining method as the joining method for the joining processing or not, by comparing the found progress and remaining quantity of the joining processing with a first threshold which is predetermined for the progress and the remaining quantity, respectively.

6. The join query execution method according to claim 5,
wherein the join query execution device calculates the progress of the joining processing by dividing the number of pieces of data, on which the joining processing has already been executed, among the search result of the external data source, by the search result count of the external data source.

7. The join query execution method according to claim 5,
wherein the join query execution device calculates the remaining quantity of the joining processing by subtracting the number of pieces of data, on which the joining processing has already been executed, from the search result count of the external data source.

8. The join query execution method according to claim 4,
wherein in the second step, when the search result count of the search processing can be acquired upon execution of the search processing on the external data source,
the join query execution device:
acquires the search result count;
calculates the progress of the joining processing by using the search result count of the external data source every time the joining processing is executed on one search result of the external data source and the table managed by the data management system; and calculates a hit rate that is a rate of data, which satisfy a joining condition, among entire data of the table for the one search result of the external data source on which the joining processing has been executed; and
determines whether the first joining method is the appropriate joining method as the joining method for the joining processing or not, by comparing the found progress of the joining processing and the hit rate with a second threshold which is predetermined for the progress and the hit rate, respectively.

9. The join query execution method according to claim 8,
wherein the join query execution device calculates the progress of the joining processing by dividing the number of pieces of data, on which the joining processing has already been executed, among the search result of the external data source, by the search result count of the external data source.

10. The join query execution method according to claim 4,
wherein when the search result count of the search processing cannot be acquired upon execution of the search processing on the external data source,
the join query execution device:
calculates remaining quantity of the joining processing every time the joining processing is executed on one search result of the external data source and the table managed by the data management system; and
determines whether the first joining method is the appropriate joining method as the joining method for the joining processing or not, by comparing the found remaining quantity of the joining processing with a third threshold which is predetermined for the remaining quantity.

11. The join query execution method according to claim 10,
wherein the join query execution device calculates the remaining quantity of the joining processing by subtracting the number of pieces of data, on which the joining processing has already been executed, from the search result count of the external data source.

12. The join query execution method according to claim 1,
wherein when it is determined in the second step that the first joining method is the appropriate joining method, the join query execution device executes the joining processing by the first joining method in the third step; and
wherein, in the second step, in case it is determined that the first joining method is not the appropriate joining method, the join query execution device switches the joining method to the second joining method in order to execute the joining processing regarding the search result on which the joining method has not been executed by the second joining method in the third step.

13. A join query execution device for searching an external data source connected to a data management system by means of a table function and executing joining processing against a join query regarding a search result of the table function and a table managed by the data management system,
the join query execution device comprising:
a table function unit that searches the external data source by issuing a search request to the external data source;
a joining execution unit that executes the joining processing regarding the search result of the table function and the table managed by the data management system by a first joining method or a second joining method whose processing speed is faster than that of the first joining method;
a switch command unit that determines whether the first joining method is an appropriate joining method as a joining method for the joining processing or not, by using information acquired by search processing on the external data source by the table function unit and/or information found during the joining processing, and gives a command to the joining execution unit to switch the joining method for the joining processing to the second joining method when it is determined that the first joining method is not the appropriate joining method as the joining method for the joining processing; and
a control unit that controls activation of the table function unit, the joining execution unit, and the switch command unit.

14. A storage medium storing a program for having a join query execution device search an external data source connected to a data management system by means of a table function and execute joining processing against a join query regarding a search result of the table function and a table managed by the data management system, wherein the processing comprising:
a first step of executing the joining processing regarding the search result of the table function and the table managed by the data management system by a first joining method;
a second step of determining whether the first joining method is an appropriate joining method as a joining method for the joining processing or not, by using information acquired by search processing on the external data source by means of the table function and/or information found during the joining processing; and
a third step, which is executed when it is determined that the first joining method is not the appropriate joining method as the joining method for the joining processing, of regarding a second joining method as the faster than the first joining method and switching the joining method for the joining processing from the first joining method to the second joining method.
